(19) United States
(12) Patent Application Publication
(10) Pub. No.: US 2025/0005176 A1
(43) Pub. Date: Jan. 2, 2025

(54) INFORMATION PROCESSING APPARATUS, INFORMATION PROCESSING METHOD, AND COMPUTER-READABLE RECORDING MEDIUM

(71) Applicant: NEC Corporation, Tokyo (JP)

(72) Inventors: Shunichi Kinoshita, Tokyo (JP); Masaki Inokuchi, Tokyo (JP); Shohei Mitani, Tokyo (JP)

(73) Assignee: NEC Corporation, Tokyo (JP)

(21) Appl. No.: 18/744,791

(22) Filed: Jun. 17, 2024

(30) Foreign Application Priority Data
Jun. 30, 2023 (JP) 2023-108605

(51) Int. Cl. G06F 21/60; G06F 21/31

(52) U.S. Cl. CPC G06F 21/604; G06F 21/31

(57) ABSTRACT

An information processing apparatus includes an access attribute estimating unit that estimates access attributes representing attributes for an access request for an information asset, transmitted to the information asset from a terminal device, a likelihood calculation unit that calculates a likelihood for each access attribute, an access risk calculation unit that calculates an access risk for the access request, using the likelihoods, and a determination unit that determines whether to permit the access request for the information asset, based on the access risk.

### CROSS-REFERENCE TO RELATED APPLICATION

This application is based upon and claims the benefit of priority from Japanese application No. 2023-108605, filed on Jun. 30, 2023, the disclosure of which is incorporated herein in its entirety by reference.

### BACKGROUND OF THE INVENTION

### 1. Field of the Invention

The present disclosure relates to an information processing apparatus, an information processing method, and a computer-readable recording medium that are for executing access control.

### 2. Background Art

Technologies for analyzing access to information assets held by organizations in order to protect the information assets from threats are known.

As related art, Patent Document 1 (International Publication No. 2022/244179) discloses a policy generation device that automatically defines access control policies. The policy generation device of Patent Document 1 acquires, for a plurality of elements related to access control, relational data showing the relationship between the elements, and score data in which at least one of a score based on a viewpoint of access risk and a score based on a viewpoint of access needs is defined, and uses the relational data and the score data to generate access control policies.

As related art, Patent Document 2 (Japanese Patent Laid-Open Publication No. 2018-142198) discloses an information processing apparatus that grants safe access rights even when authentication accuracy is low. The information processing apparatus of Patent Document 2, first, derives index values representing the possibility that an authentication target is each of a plurality of registered users, based on the degree of matching between feature values extracted from authentication information acquired from the authentication target and the respective feature values of the plurality of registered users whose feature values have been acquired in advance. Next, the information processing apparatus sets combined access rights by combining access rights for a plurality of resources of a certain user among the plurality of registered users and access rights for a plurality of resources of users other than the certain user among the plurality of registered users, based on the index values. Next, the information processing apparatus permits the authentication target to access resources whose access is permitted by the combined access rights.

However, with the technologies of Patent Documents 1 and 2, the risk assessment for access to information assets is inadequate, and thus there is a possibility of excessive access restrictions being applied despite risk being acceptable, or access that includes unacceptable risk being granted.

### SUMMARY OF THE INVENTION

An example object of the disclosure is to determine whether to permit access to information assets, based on risk with respect to access to information assets that takes account of likelihood.

In order to achieve the above object, an information processing apparatus according to one aspect of the present disclosure includes:
an access attribute estimating unit that estimates access attributes representing attributes for an access request for an information asset, transmitted to the information asset from a terminal device;
a likelihood calculation unit that calculates a likelihood for each access attribute;
an access risk calculation unit that calculates an access risk for the access request, using the likelihoods; and
a determination unit that determines whether to permit the access request for the information asset, based on the access risk.

Also, in order to achieve the above object, an information processing method according to one aspect of the present disclosure is performed by an information processing apparatus, the method comprising:
estimating access attributes representing attributes for an access request for an information asset, transmitted to the information asset from a terminal device;
calculating a likelihood for each access attribute;
calculating an access risk for the access request, using the likelihoods; and
determining whether to permit the access request for the information asset, based on the access risk.

Furthermore, in order to achieve the above object, a computer-readable recording medium according to one aspect of the present disclosure includes a program recorded thereon, the program including instructions that causes a computer to carry out:
estimating access attributes representing attributes for an access request for an information asset, transmitted to the information asset from a terminal device;
calculating a likelihood for each access attribute;
calculating an access risk for the access request, using the likelihoods; and
determining whether to permit the access request for the information asset, based on the access risk.

According to the disclosure as described above, it can be determined whether to permit access to information assets, based on risk with respect to access to information assets that takes account of likelihood.

### BRIEF DESCRIPTION OF THE DRAWINGS

FIG. 1 is for describing an example configuration of an information processing apparatus of a first example embodiment.

FIG. 2 is for describing an example configuration of a system having the information processing apparatus of the first example embodiment.

FIG. 3 is for describing an example of access attribute estimation and likelihood calculation of the first example embodiment.

FIG. 4 is for describing an example of access attribute estimation and likelihood calculation of the first example embodiment.

FIG. 5 is for describing an example of access risk calculation of the first example embodiment.

FIG. 6 is for describing example operations of the information processing apparatus of the first example embodiment.

FIG. 7 is for describing an example of access risk calculation of a first example modification.

FIG. 8 is for describing an example configuration of a system including an information processing apparatus of a second example embodiment.

FIG. 9 is for describing an example of access needs calculation of the second example embodiment.

FIG. 10 is for describing an example of access permission of the second example embodiment.

FIG. 11 is for describing example operations of the information processing apparatus of the second example embodiment.

FIG. 12 is for describing an example of access permission of the second example modification.

FIG. 13 is for describing an example configuration of a system of a third example modification.

FIG. 14 is for describing an example of a computer that realizes the information processing apparatus of any of the first example embodiment, the first example modification, the second example embodiment, and the second and third example modifications.

### EXAMPLE EMBODIMENTS

Hereinafter, embodiments will be described with reference to the drawings. Note that, in the drawings described below, elements having the same functions or corresponding functions will be given the same reference numerals, and repetitive description thereof may be omitted.

### First Example Embodiment

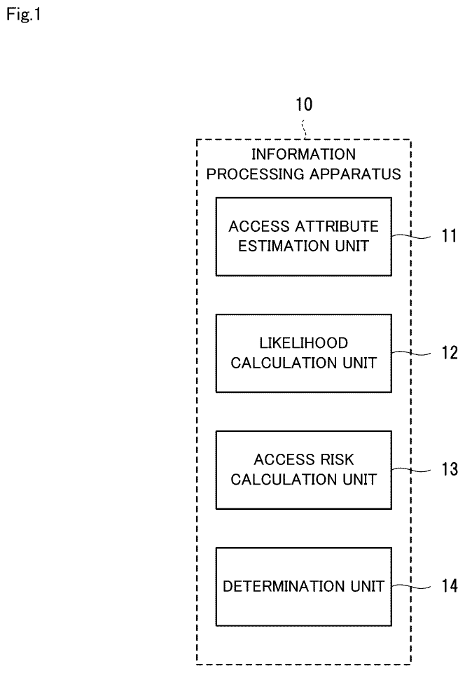

A first example embodiment will now be described using FIG. 1. FIG. 1 is for describing an example configuration of an information processing apparatus of the first example embodiment.

### [Apparatus Configuration]

In the example shown in FIG. 1, an information processing apparatus 10 determines whether to permit access, based on risk with respect to access to information assets. Also, in the example shown in FIG. 1, the information processing apparatus 10 includes an access attribute estimation unit 11, a likelihood calculation unit 12, an access risk calculation unit 13, and a determination unit 14.

The access attribute estimation unit 11 estimates access attributes representing attributes for an access request for an information asset, transmitted to the information asset from a terminal device.

Access attributes include, for example, information representing users of the terminal devices (user identification information), information representing roles of the users (user role information), and information representing labels of the information assets (information asset label information). Access attributes are, however, not limited to the above-described user identification information, user role information, and information asset label information.

The user identification information is, for example, information identifying the user using a terminal device. The user role information is, for example, information representing the user's position and affiliation within an organization, and the like.

The information asset label information is, for example, information representing the type of information asset, information indicating whether the information asset includes personal information, and the like. Information representing the type of information asset is, for example, information representing whether files held by the information asset include confidential information. Personal information is, for example, customer information included in files held by the information asset.

The likelihood calculation unit 12 calculates likelihoods for access attributes. A likelihood is calculated for each of the user identification information, user role information, and information asset label information, for example. The calculation of likelihoods (likelihood calculation processing) may, for example, be performed by any program that is able to calculate likelihoods. Note that the access attribute estimation unit 11 and the likelihood calculation unit 12 may be constituted by an element that integrates these units. That is, such an element may be configured to derive attributes for an access request for an information asset together with the likelihoods thereof.

The access risk calculation unit 13 calculates the access risk for an access request using the likelihoods. Specifically, first, the access risk calculation unit 13 derives an attribute risk for each combination of access attributes. Next, the access risk calculation unit 13 calculates an access risk for the access request, using the derived attribute risks and the likelihoods.

Attribute risks corresponding to the combinations of access attributes are derived with reference to attribute risk assessment information, created in advance and stored in a storage device, in which combinations of access attributes are associated with attribute risks, for example.

Also, attribute risks may be derived by, for example, inputting combinations of access attributes into an attribute risk derivation model. The attribute risk derivation model is, for example, a trained machine learning model.

The attribute risk derivation model may be created, for a certain set of access requests, using, as learning data, data in which combinations of the access attributes are explanatory variables and label information indicating whether access is permitted is an objective variable, for example.

The set of access requests may be a list of anticipated access requests compiled by an administrator or the like. Alternatively, the set of access requests may be access requests extracted from past access logs. Also, in each access request, access attributes and a label indicating whether access is permitted may be set by an administrator or the like.

The access risk is calculated using the weighted sum of likelihoods, using the plurality of likelihoods for each access attribute included in the combinations and the attribute risk derived for each combination of access attributes, for example.

Also, the access risk for an access request may be derived, for example, by inputting combinations of access attributes and the likelihoods for each combination of access attributes into an access risk derivation model. The access risk derivation model is, for example, a trained machine learning model.

The access risk derivation model may, for example, be created, for a certain set of access requests, using, as learning data, data in which combinations of the access attributes are explanatory variables and label information indicating whether access is permitted is an objective variable.

The set of access requests may be a list of anticipated access requests compiled by an administrator or the like. Alternatively, the set of access requests may be access requests extracted from past access logs. Also, in each access request, access attributes and a label indicating whether access is permitted may be set by an administrator or the like.

The determination unit 14 determines whether to permit an access request for an information asset, based on the access risk. Specifically, the determination unit 14 permits an access request for an information asset when the access risk is less than or equal to a threshold set in advance. Conversely, the determination unit 14 does not permit an access request for an information asset when the access risk exceeds the preset threshold.

In this way, in the first example embodiment, it can be determined whether to permit access, based on risk with respect to access to information assets.

### [System Configuration]

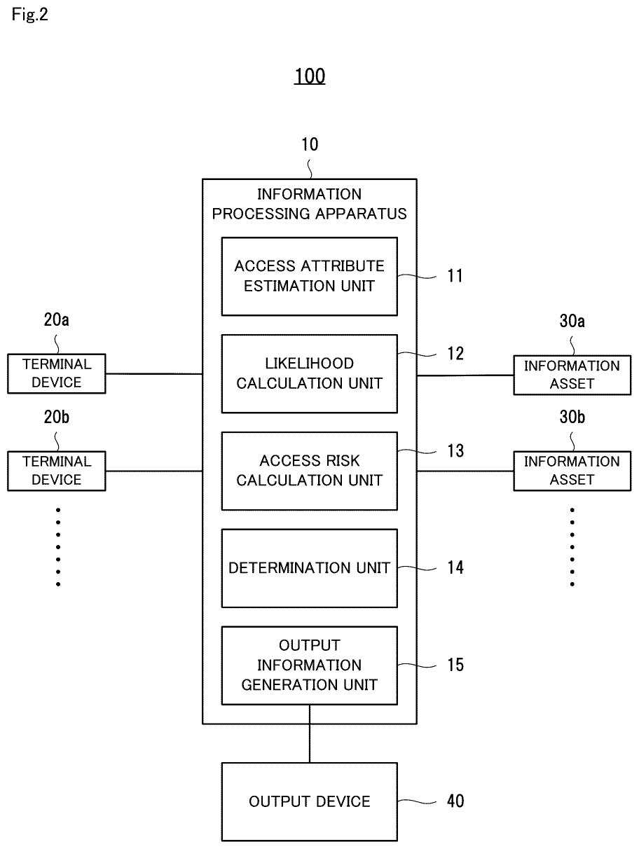

A system 100 that includes the information processing apparatus 10 will now be described using FIG. 2. FIG. 2 is for describing an example configuration of the system having the information processing apparatus of the first example embodiment.

In the example shown in FIG. 2, the system 100 includes the information processing apparatus 10, terminal devices 20 (20a, 20b . . . ), information assets 30 (30a, 30b . . . ), and an output device 40. Also, the information processing apparatus 10, the terminal devices 20 (20a, 20b . . . ), the information assets 30 (30a, 30b, . . . ), and the output device 40 are connected to a network. The output device 40 need not, however, be provided in the system 100.

The network is, for example, a general network built using communication lines such as the Internet, a LAN (Local Area Network), leased lines, telephone lines, a corporate network, a mobile communication network, Bluetooth (registered trademark), and Wi-Fi (Wireless Fidelity) (registered trademark).

The information processing apparatus 10 is, for example, a CPU (Central Processing Unit), a programmable device such as an FPGA (Field-Programmable Gate Array), a GPU (Graphics Processing Unit), a circuit on which at least one of the above devices is realized, or an information processing apparatus such as a server computer, a personal computer or a mobile terminal. Note that the information processing apparatus 10 may be provided in a device such as a communication device.

The terminal devices 20 (20a, 20b . . . ) are each, for example, a CPU, an FPGA, a circuit on which at least one of the above devices is realized, or an information processing apparatus such as a personal computer or a mobile terminal.

The information assets 30 (30a, 30b . . . ) are each, for example, a CPU, an FPGA, a circuit on which at least one of the above devices is realized, a storage device (database, etc.), an information processing apparatus such as a server computer, or any of various control apparatuses, or alternatively a file, service or API (Application Programing Interface) provided thereon.

The output device 40 acquires output information converted into a format that can be output, and outputs generated images, audio and the like, based on the output information. The output device 40 is, for example, an image display device that uses liquid crystal, organic EL (Electro-Luminescence), CRTs (Cathode Ray Tubes), or the like. Furthermore, the image display device may include an audio output device such as a speaker. Note that the output device 40 may also be a printing device such as a printer.

The information processing apparatus 10 will now be described in detail.

In the example shown in FIG. 2, the information processing apparatus 10 includes the access attribute estimation unit 11, the likelihood calculation unit 12, the access risk calculation unit 13, the determination unit 14, and the output information generation unit 15. The output information generation unit 15 need not, however, necessarily be provided in the information processing apparatus 10.

First, when an access request is transmitted to an information asset 30 from a terminal device 20 (whenever an access request is generated), the access attribute estimation unit 11 receives the access request for the information asset 30. Next, the access attribute estimation unit 11 estimates attributes (access attributes) of the received access request. Next, the access attribute estimation unit 11 outputs the estimated access attributes to the likelihood calculation unit 12.

Specifically, the access attribute estimation unit 11 estimates the access attributes for the access request with reference to one or more of information included in the access request and information stored in the storage device (not shown) in advance.

The information is at least one of information such as past access logs, information relating to the network architecture within an organization, past communication states, statistical information of past communication states, information on past security audits, personnel information, asset registers, NDR (Network Detection and Response), IDS (Intrusion Detection System), UEM (Unified Endpoint Management), firewalls, EDR (Endpoint Detection and Response), AD (Active Directory) (registered trademark), and proxy logs.

In addition to user, user role (position, affiliation), confidentiality classification of files held by information assets, and personal information included in files held by information assets, conceivable access attributes include the security status of a device (host) on a network, the security status of communication channels, and the type of device that transmitted the access request. The access attributes are, however, not limited to the above-described attributes.

User (user identification information) and user role (user role information) are estimated based on past access logs, for example. Also, information asset label information (confidentiality classification of files held by information assets, personal information included in files held by information assets) are estimated by executing natural language processing on text included in files, and the like, for example.

The security status of a host is estimated by, for example, estimating whether the host has vulnerabilities and the number or severity of the vulnerabilities, based on information on the host's past vulnerability scans and the number of days since a certain point in time. The certain point in time can, for example, be the date-time of a past vulnerability scan, the setup date-time of the host, or the date-time of a security update of the host.

The security status of communication channels is estimated by, for example, estimating protocols and cipher suites that are used in access.

Estimation of the type of device that transmitted the access request is, for example, performed depending on whether the communication content of other communication whose source IP address matches the access request includes information matching a signature defined in advance.

First, the likelihood calculation unit 12 acquires access attributes. Next, the likelihood calculation unit 12 calculates likelihoods for the acquired access attributes. Next, the likelihood calculation unit 12 outputs the calculated likelihoods to the access risk calculation unit 13.

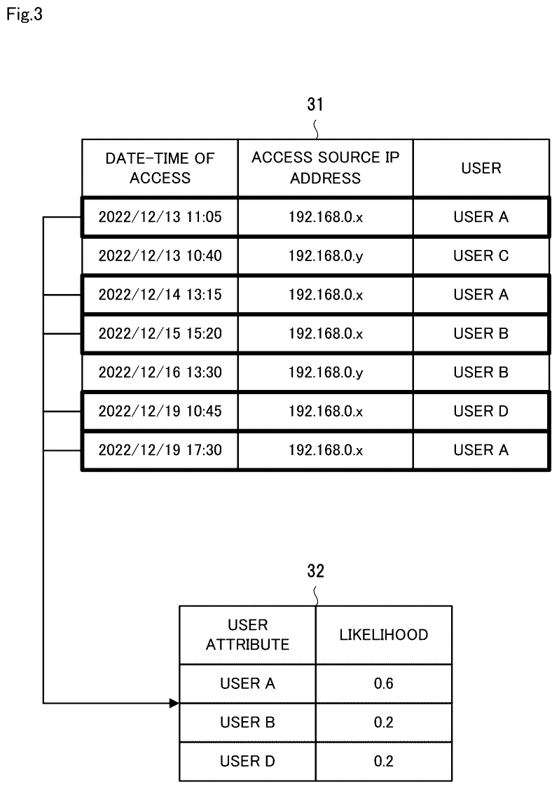

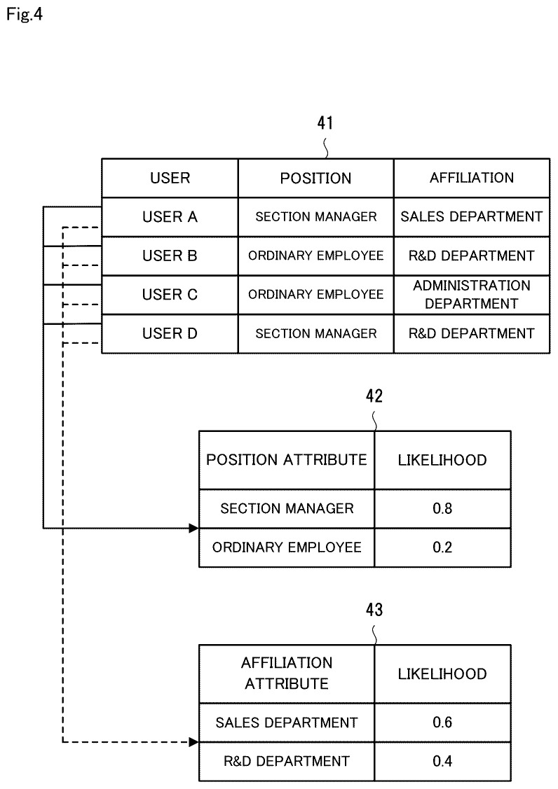

The likelihood calculation unit 12 will now be described using FIGS. 3 and 4. FIGS. 3 and 4 are for describing an example of access attribute estimation and likelihood calculation of the first example embodiment.

FIG. 3 shows an example of access attribute estimation and likelihood calculation performed on the user attribute, when the access source IP address is “192.168.0.x”. In the example shown in FIG. 3, first, the access attribute estimation unit 11 refers to an access log 31 and extracts records (lines) corresponding to the access source IP address “192.168.0.x”, and derives user candidates as access attributes. Next, the likelihood calculation unit 12 refers to the access log 31 and extracts records (lines) corresponding to the access source IP address “192.168.0.x”. Next, the likelihood calculation unit 12 calculates likelihoods for the users included in the extracted records.

In the example shown in FIG. 3, the users included in the extracted records are “user A”, “user B”, and “user D”. Furthermore, as shown in Table 32, because five records are extracted and three of the records include “user A”, the likelihood for “user A” (user attribute) will be “0.6” (=⅗). Also, the likelihood for “user B” (user attribute) will be “0.2” (=⅕). The likelihood for “user D” (user attribute) will also be “0.2” (=⅕).

Next, in the example shown in FIG. 4, first, the likelihood calculation unit 12 extracts the positions of the users with reference to personnel information 41. Next, the likelihood calculation unit 12 calculates the likelihood for each extracted position. In the example shown in FIG. 4, the users are “user A”, “user B”, and “user D”, of which “user A” and “user D” are section managers (position attribute). The likelihood for the position “section manager” (position attribute) will thus be “0.8”, obtained by adding the likelihood “0.6” of “user A” to the likelihood “0.2” of “user D”. Also, since “user B” is the only user out of “user A”, “user B”, and “user D” whose position is “ordinary employee”, the likelihood for the position “ordinary employee” (position attribute) will be “0.2”, obtained by using the likelihood “0.2” of “user B”.

Also, in the example shown in FIG. 4, the likelihood calculation unit 12 extracts the affiliations of the users, with reference to the personnel information 41. Next, the likelihood calculation unit 12 calculates the likelihood for each extracted affiliation. In the example shown in FIG. 4, the users are “user A”, “user B”, and “user D”, of which only “user A” belongs to the sales department (affiliation attribute). The likelihood for the affiliation “sales department” (affiliation attribute) will thus be “0.6”, obtained by using the likelihood “0.6” of “user A”. Also, since “user B” and “user D”, out of “user A”, “user B”, and “user D”, belong to the R&D department (affiliation attribute), the likelihood for the affiliation “R&D department” (affiliation attribute) will be “0.4”, obtained by adding together the likelihood “0.2” of “user B” and the likelihood “0.2” of “user D”.

Note that likelihoods are also calculated for attributes other than those described above with a predetermined calculation method set in advance. The calculation method may be any method that is able to calculate likelihoods for attributes.

Also, an access attribute that is usable without being estimated will have a likelihood of 1.

The access risk calculation unit 13, first, uses the estimated access attributes to generate combinations of the estimated access attributes. Next, the access risk calculation unit 13 derives an attribute risk for each combination of access attributes. Note that the attribute risks are derived using attribute risk assessment information, an attribute risk derivation model, or the like, for example, as described above.

Next, the access risk calculation unit 13 calculates the access risk for the access request using the derived attribute risks and the likelihoods calculated by the likelihood calculation unit 12. Specifically, the access risk calculation unit 13 calculates the access risk (weighted sum of likelihoods), using the plurality of likelihoods for each access attribute included in the combinations and the attribute risk set for each combination of access attributes.

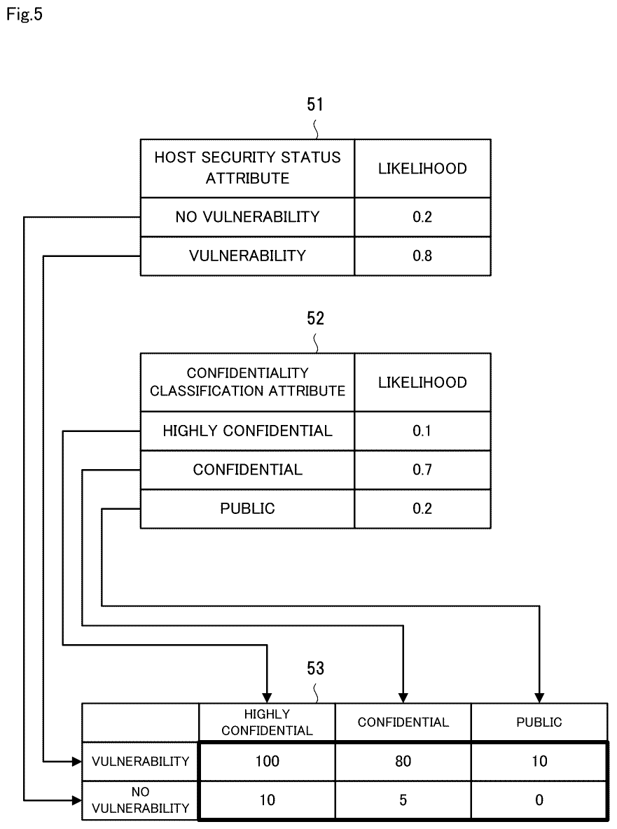

An example of calculating the access risk will now be described using FIG. 5. FIG. 5 is for describing an example of access risk calculation of the first example embodiment.

In the example shown in FIG. 5, the case where the combination of access attributes is “host security status attribute” and “confidentiality classification attribute” will now be described. Also, in the example shown in FIG. 5, with respect to the likelihoods for “host security status attribute”, the likelihood for “no vulnerabilities” is “0.2” and the likelihood for “vulnerabilities” is “0.8”, as shown in likelihood information 51. Also, with respect to the likelihoods for “confidentiality classification attribute”, the likelihood for “highly confidential” is “0.1”, the likelihood for “confidential” is “0.7”, and the likelihood for “public” is “0.2”, as shown in likelihood information 52.

Furthermore, assume that, in attribute risk assessment information 53, attribute risk “100” is preset for the combination “vulnerabilities, highly confidential”, attribute risk “80” is preset for the combination “vulnerabilities, confidential”, attribute risk “10” is preset for the combination “vulnerabilities, public”, attribute risk “10” is preset for the combination “no vulnerabilities, highly confidential”, attribute risk “5” is preset for the combination “no vulnerabilities, confidential” and attribute risk “0” is preset for the combination “no vulnerabilities, public”.

Note that the attribute risks of the attribute risk assessment information 53 described above are conceivably determined by testing, simulation, or the like, for example.

Under the conditions described above, the access risk can be calculated using a weighted sum of likelihoods, such as shown in Equation 1.

$$( Equation 1 )$$

$$\begin{matrix}Access risk Ar = 0.8 \times 0.1 \times 100 ( vulnerabilities , highly confidential ) \\ + 0.8 \times 0.7 \times 80 ( vulnerabilities , confidential ) \\ + 0.8 \times 0.2 \times 10 ( vulnerabilities , Public ) \\ + 0.2 \times 0.1 \times 10 ( no vulnerabilities , highly confidential ) \\ + 0.2 \times 0.7 \times 5 ( ( no vulnerabilities , confidential ) \\ + 0.2 \times 0.2 \times 0 ( ( no vulnerabilities , public ) \\ = 55.3\end{matrix}$$

Note that the access risk may be derived using an access risk derivation model. In that case, data in which combinations of access attributes are associated with likelihoods corresponding to the combinations of access attributes is input into the access risk derivation model, and the access risk for the access request is output.

First, the determination unit 14 acquires the access risk. Next, the determination unit 14 determines whether the access risk is less than or equal to a threshold set in advance. Next, if the access risk is less than or equal to the preset threshold (determination threshold), the determination unit 14 permits the access request for the information asset. Conversely, if the access risk exceeds the preset threshold, the determination unit 14 does not permit the access request for the information asset.

Note that the determination threshold is conceivably determined by testing, simulation, or the like, for example.

The output information generation unit 15 generates output information for outputting, to the output device 40, one or more of the access request, estimated access attributes, likelihoods, attribute risks, access risk, determination result, and statistical information thereof. Next, the output information generation unit 15 outputs the generated output information to the output device 40.

Note that the information processing apparatus 10 may store a log of determination results for access requests in a storage device.

### [Apparatus Operations]

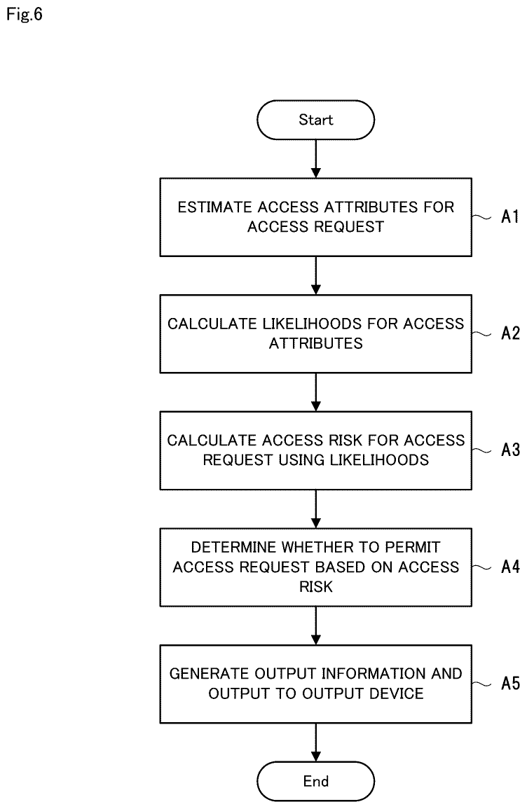

Example operations of the information processing apparatus of the first example embodiment will now be described using FIG. 6. FIG. 6 is for describing example operations of the information processing apparatus of the first example embodiment. In the following description, FIG. 6 will be referred to as appropriate. Also, in the first example embodiment, an information processing method is implemented by operating the information processing apparatus. Therefore, the following description of operations of the information processing apparatus will be given in place of description of the information processing method of the first example embodiment.

As shown in FIG. 6, the access attribute estimation unit 11 estimates access attributes representing attributes for an access request for an information asset, transmitted to the information asset from a terminal device (step A1).

Specifically, in step A1, the access attribute estimation unit 11, first, receives an access request for an information asset 30, transmitted to the information asset 30 from a terminal device 20. Next, in step A1, the access attribute estimation unit 11 estimates attributes (access attributes) of the received access request. Next, the access attribute estimation unit 11 outputs the estimated access attributes to the likelihood calculation unit 12.

Next, the likelihood calculation unit 12 calculates likelihoods for the access attributes (step A2). Specifically, in step A2, first, the likelihood calculation unit 12 acquires the access attributes from the access attribute estimation unit 11. Next, in step A2, the likelihood calculation unit 12 calculates likelihoods for the acquired access attributes. Next, in step A2, the likelihood calculation unit 12 outputs the calculated likelihoods to the access risk calculation unit 13. Note that step A1 and step A2 may be integrated as one step. That is, the attributes (access attributes) of the received access request may be estimated and the likelihoods thereof may be calculated.

The access risk calculation unit 13 calculates an access risk for the access request, using the likelihoods (step A3). Specifically, in step A3, first, the access risk calculation unit 13 uses the estimated access attributes to generate combinations of the estimated access attributes. Next, in step A3, the access risk calculation unit 13 derives an attribute risk for each combination of access attributes. Note that the attribute risks are derived using attribute risk assessment information, an attribute risk derivation model, or the like, for example.

Next, in step A3, the access risk calculation unit 13 calculates the access risk for the access request, using the derived attribute risks and the likelihoods calculated by the likelihood calculation unit 12.

Specifically, the access risk calculation unit 13 calculates the access risk (weighted sum of likelihoods), using the plurality of likelihoods for each access attribute included in the combinations and the attribute risk set for each combination of access attributes. Alternatively, the access risk calculation unit 13 may derive the access risk using an access risk derivation model.

The determination unit 14 determines whether to permit the access request for the information asset, based on the access risk (step A4). Specifically, in step A4, the determination unit 14, first, acquires the access risk. Next, in step A4, the determination unit 14 determines whether the access risk is less than or equal to a threshold set in advance. Next, in step A4, the determination unit 14 permits the access request for the information asset, if the access risk is less than or equal to the preset threshold (determination threshold). Conversely, in step A4, the determination unit 14 does not permit the access request for the information asset, if the access risk exceeds the preset threshold.

The output information generation unit 15 generates output information and outputs the output information to the output device 40 (step A5). Specifically, in step A5, the output information generation unit 15 generates output information for outputting, to the output device 40, one or more of the access request, estimated access attributes, likelihoods, attribute risks, access risk, determination result, and statistical information thereof. Next, in step A5, the output information generation unit 15 outputs the generated output information to the output device 40. Note that step A5 may be omitted.

In this way, the information processing apparatus 10 repeats the processing of steps A1 to A4. Note that the processing of step A5 may be repeated, or may be executed as appropriate.

### Effects of First Example Embodiment

According to the first example embodiment as described above, it can be determined whether to permit access, based on risk with respect to access to information assets. In particular, according to the first example embodiment, assessment of risk takes account of the likelihoods for access attributes, and thus it can be determined whether to permit access, based on a more precise assessment of risk.

### First Example Modification

A first example modification will now be described. The first example modification differs from the first example embodiment in that the likelihood calculation unit 12 calculates likelihoods for combinations that use all the estimated access attributes. Note that because the operations of the access attribute estimation unit 11, the access risk calculation unit 13, and the determination unit 14 are the same as in the first example embodiment, detailed description thereof will be omitted in the first example modification.

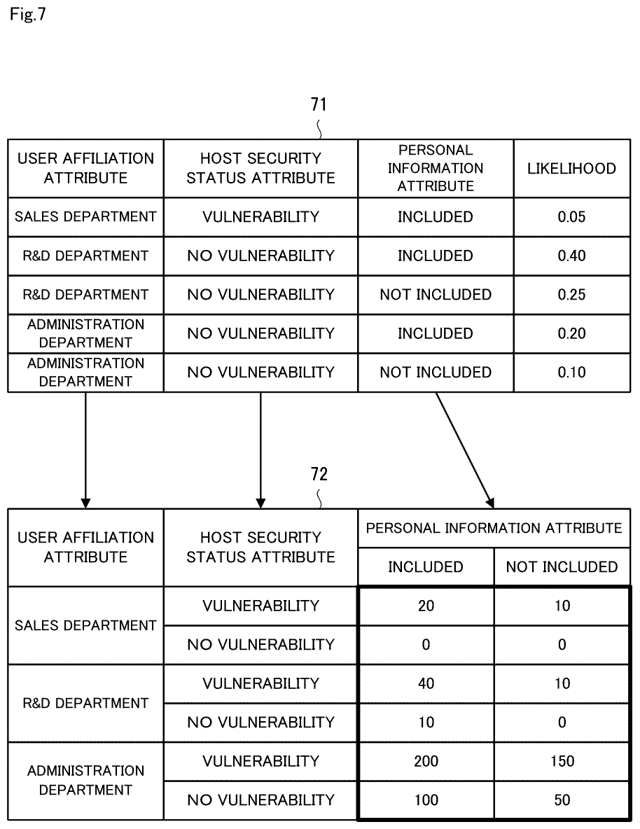

The case where likelihoods are calculated for combinations that use all of the estimated access attributes will now be described using FIG. 7. FIG. 7 is for describing an example of access risk calculation of the first example modification.

In the example of the first example modification shown in FIG. 7, the estimated access attributes are the access attributes “user affiliation attribute”, “host security status attribute”, and “personal information attribute”. Also, Table 71 represents the likelihoods for combinations of the estimated access attributes.

That is, as shown in Table 71, the likelihood calculation unit 12 calculates “0.05” as the likelihood for “sales department, vulnerabilities, included”, “0.40” as the likelihood for “R&D department, no vulnerabilities, included”, “0.25” as the likelihood for “R&D department, no vulnerabilities, not included”, “0.20” as the likelihood for “administration department, no vulnerabilities, included”, and “0.10” as the likelihood for “administration department, no vulnerabilities, not included”.

Next, the access risk calculation unit 13 derives attribute risks, using attribute risk assessment information, an attribute risk derivation model, or the like, for example, as described above. For example, attribute risks are derived using attribute risk assessment information 72 shown in FIG. 7.

Next, the access risk calculation unit 13 calculates the access risk for the access request, using the derived attribute risks and the likelihoods calculated by the likelihood calculation unit 12.

Note that the attribute risks of the attribute risk assessment information 72 described above are conceivably determined by testing, simulation, or the like, for example.

Under the conditions described above, the access risk is formulated as an equation representing the weighted sum of likelihoods, such as shown in Equation 2.

$$( Equation 2 )$$

$$\begin{matrix}Access risk Ar = 0.05 \times 20 ( sales department , vulnerabilities , included ) \\ + 0.4 \times 10 ( R \& D department , no vulnerabilities , included ) \\ + 0.25 \times 0 ( R \& D department , no vulnerabilities , \\ not included ) \\ + 0.2 \times 100 ( administration department , no vulnerabilities , \\ included ) \\ + 0.1 \times 50 ( administration department , no vulnerabilities , \\ not included ) \\ = 30\end{matrix}$$

Note that combinations of access attributes with a small likelihood (less than or equal to an exclusion threshold set in advance) may be excluded. For example, in the example of Table 71, records (lines) in which the likelihood is 0.05 or less are excluded.

Under the conditions described above, the access risk is then formulated as an equation representing the weighted sum of likelihoods, such as shown in Equation 3.

$$( Equation 3 )$$

$$\begin{matrix}Access risk Ar = 0.4 \times 10 ( R \& D department , no vulnerabilities , included ) \\ + 0.25 \times 0 ( R \& D department , no vulnerabilities , \\ not included ) \\ + 0.2 \times 100 ( administration department , no vulnerabilities , \\ included ) \\ + 0.1 \times 50 ( administration department , no vulnerabilities , \\ not included ) \\ = 29\end{matrix}$$

Note that, in the above-described description, the access risk is calculated using an equation representing the weighted sum, but may be derived using an access risk derivation model.

### Effects of First Example Modification

According to the first example modification as described above, it can be determined whether to permit access, based on risk with respect to access to information assets. In particular, according to the first example modification, risk assessment takes account of the likelihoods for access attributes, and thus it can be determined whether to permit access, based on a more precise assessment of risk.

### [Program]

The program according to the first example embodiment and the first example modification may be a program that causes a computer to execute steps A1 to A5 shown in FIG. 6. By installing this program in a computer and executing the program, the information processing apparatus 10 and the information processing method according to the first example embodiment and the first example modification can be realized. Further, the processor of the computer performs processing to function as the access attribute estimation unit 11, the likelihood calculation unit 12, the access risk calculation unit 13, the determination unit 14, and the output information generation unit 15.

Also, the program according to the first example embodiment and the first example modification may be executed by a computer system constructed by a plurality of computers. In this case, for example, each computer may function as any of the access attribute estimation unit 11, the likelihood calculation unit 12, the access risk calculation unit 13, the determination unit 14, and an output information generation unit 15.

### Second Example Embodiment

A second example embodiment will now be described. The second example embodiment differs from the first example embodiment in that access needs are used in determining whether to permit access to information assets. Note that because the access attribute estimation unit 11, the likelihood calculation unit 12, and the access risk calculation unit 13 are described in the first example embodiment, detailed description thereof will be omitted in the second example embodiment.

### [System Configuration]

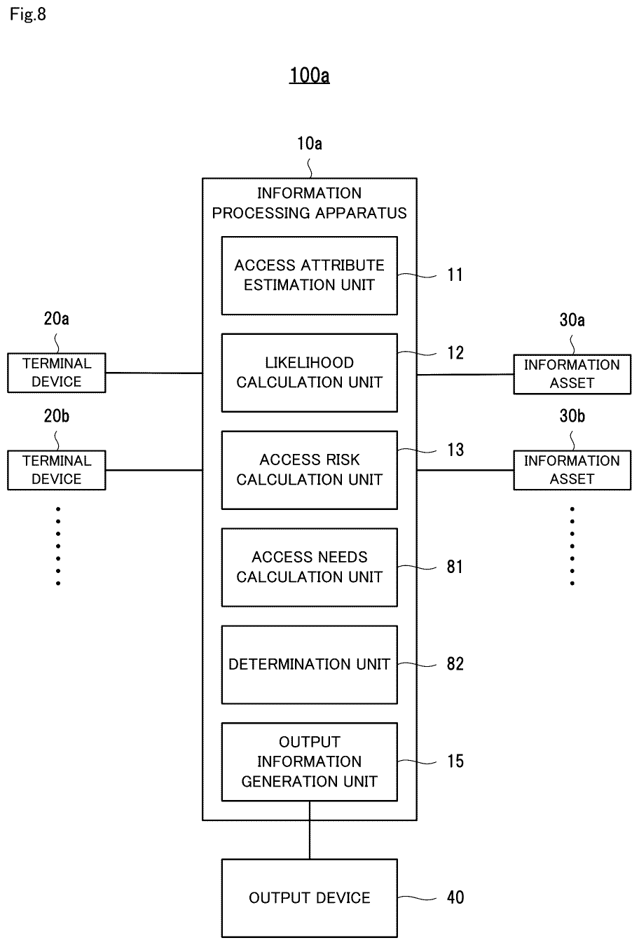

A system 100a that includes an information processing apparatus 10a will now be described using FIG. 8. FIG. 8 is for describing an example configuration of the system having the information processing apparatus of the second example embodiment.

In the example shown in FIG. 8, the system 100a includes the information processing apparatus 10a, the terminal devices 20 (20a, 20b . . . ), the information assets 30 (30a, 30b . . . ), and the output device 40. Also, the information processing apparatus 10a, the terminal devices 20 (20a, 20b . . . ), the information assets 30 (30a, 30b . . . ), and the output device 40 are connected to a network. The output device 40 need not, however, be provided in the system 100a.

Note that because the terminal devices 20 (20a, 20b . . . ), the information assets 30 (30a, 30b), and the output device 40 are described in the first example embodiment, detailed description thereof will be omitted.

The information processing apparatus 10a will now be described in detail.

In the example shown in FIG. 8, the information processing apparatus 10a includes the access attribute estimation unit 11, the likelihood calculation unit 12, the access risk calculation unit 13, an access needs calculation unit 81, a determination unit 82, and the output information generation unit 15. The output information generation unit 15 need not, however, be provided in the information processing apparatus 10a.

The access needs calculation unit 81 calculates the operational access needs for an access request, using the likelihoods for access attributes. Attribute needs of attribute needs assessment information represent the degree of operational necessity of access having those attributes. Note that the attribute needs are conceivably determined by testing, simulation, or the like, for example.

Specifically, the access needs calculation unit 81, first, derives the attribute needs for each combination of estimated access attributes, with reference to attribute needs assessment information, stored in a storage device (not shown) in advance, in which combinations of access attributes are associated with attribute needs for each combination of access attributes. The access needs calculation unit 81 derives attribute needs, using the attribute needs assessment information, an attribute needs derivation model, or the like.

Next, the access needs calculation unit 81 calculates the access needs for the access request, using the derived attribute needs and the likelihoods calculated by the likelihood calculation unit 12. Specifically, the access needs calculation unit 81 calculates the access needs (weighted sum of likelihoods), using the plurality of likelihoods for each access attribute included in the combinations and the attribute needs set for each combination of access attributes.

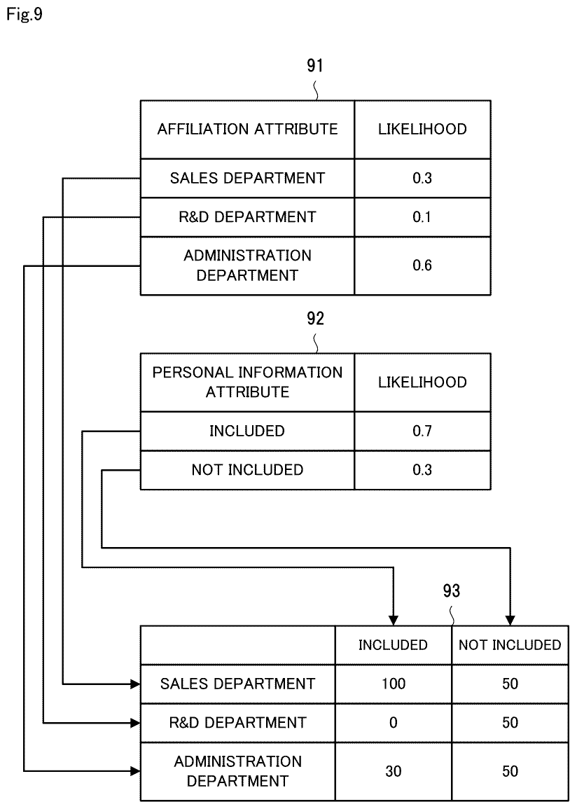

An example of access needs calculation will now be described using FIG. 9. FIG. 9 is for describing an example of access needs calculation of the second example embodiment.

In the example shown in FIG. 9, the case where the combination of access attributes is “affiliation attribute” and “personal information attribute” will now be described. Also, in the example shown in FIG. 9, with respect to the likelihoods for the “affiliation attribute”, the likelihood for “sales department” is “0.3”, the likelihood for “R&D department” is “0.1”, and the likelihood for “administration department” is “0.6”, as shown in likelihood information 91. Also, with respect to the likelihoods for the “personal information attribute”, the likelihood for the case where personal information is “included” is “0.7”, and the likelihood for the case where personal information is “not included” is “0.3”, as shown in the likelihood information 92 in FIG. 9.

Furthermore, assume that, in attribute needs assessment information 93, attribute needs “100” is preset for the combination “sales department, included”, attribute needs “50” is preset for the combination “sales department, not included”, attribute needs “0” is preset for the combination “R&D department, included”, attribute needs “50” is preset for the combination “R&D department, not included”, attribute needs “30” is preset for the combination “administration department, included”, and attribute needs “50” is preset for the combination “administration department, not included”.

Note that the attribute needs in the attribute needs assessment information 93 described above are conceivably determined by testing, simulation, or the like, for example.

Next, the access needs calculation unit 81 calculates the access needs. Under the conditions described above, the access needs can be calculated using a weighted sum of likelihoods, such as shown in Equation 4.

$$( Equation 4 )$$

$$\begin{matrix}Access Needs An = 0.3 \times 0.7 \times 100 ( sales department , included ) \\ + 0.3 \times 0.3 \times 50 ( sales department , not included ) \\ + 0.1 \times 0.7 \times 0 ( R \& D department , included ) \\ + 0.1 \times 0.3 \times 50 ( R \& D department , not included ) \\ + 0.6 \times 0.7 \times 30 ( administration department , included ) \\ + 0.6 \times 0.3 \times 50 ( administration department , not included ) \\ = 48.6\end{matrix}$$

Note that the access needs may be derived using an access needs derivation model. In that case, data in which combinations of access attributes are associated with likelihoods corresponding to the combinations of access attributes is input into the attribute needs derivation model, and the access needs for the access request are output.

The determination unit 82 determines whether to permit the access request for the information asset, based on the access risk and access needs. Specifically, the determination unit 82, first, acquires the access risk calculated by the access risk calculation unit 13 and the access needs calculated by the access needs calculation unit 81.

Next, the determination unit 82 permits the access request for the information asset, if the access needs exceed the access risk. Conversely, if the access needs are less than or equal to the access risk, the determination unit 82 does not permit the access request for the information asset.

Alternatively, the determination unit 82 determines whether to permit the access request for the information asset, based on access permission information stored in advance in a storage device (not shown).

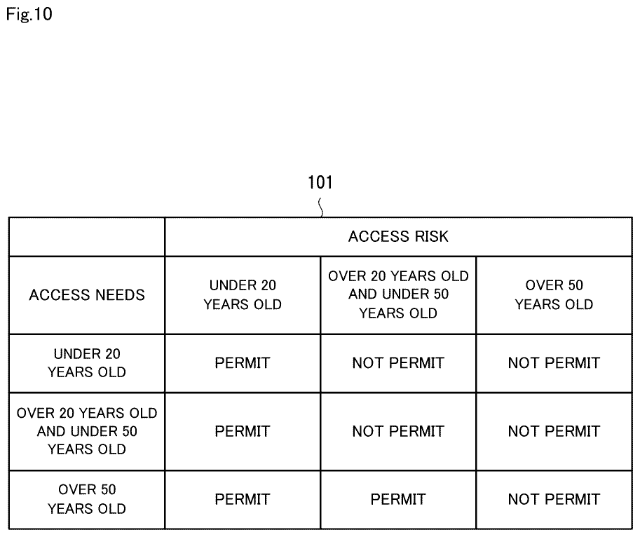

An example of access permission will now be described using FIG. 10. FIG. 10 is for describing an example of access permission of the second example embodiment. In the example shown in FIG. 10, it is determined whether to permit an access request for an information asset, with reference to access permission information 101, using the access needs and access risks.

The output information generation unit 15 generates output information for outputting, to the output device 40, one or more of the access request, estimated access attributes, likelihoods, attribute risks, access risk, attribute needs, access needs, determination result, and statistical information thereof. Next, the output information generation unit 15 outputs the generated output information to the output device 40.

### [Apparatus Operations]

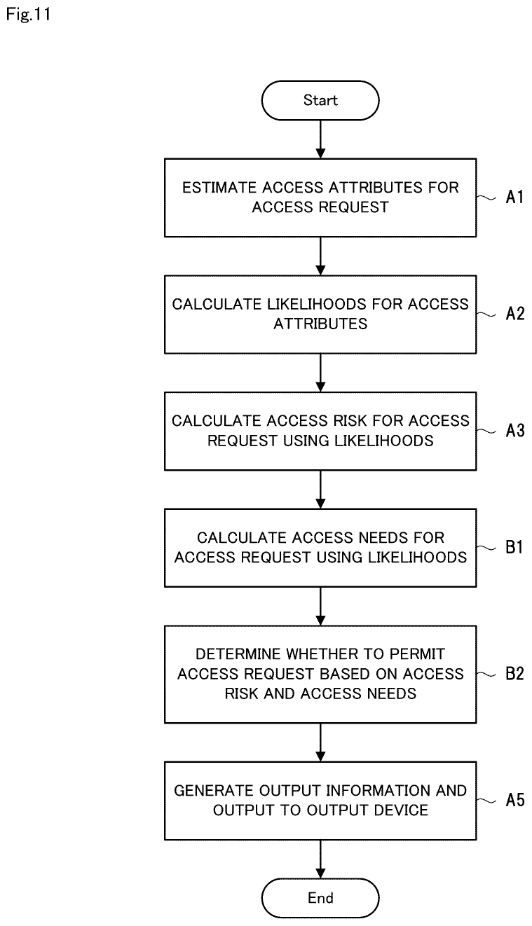

Example operations of the information processing apparatus of the second example embodiment will now be described, with reference to FIG. 11. FIG. 11 is for describing example operations of the information processing apparatus of the second example embodiment. In the following description, FIG. 11 will be referred to as appropriate. Also, in the second example embodiment, an information processing method is implemented by operating the information processing apparatus. Therefore, the following description of operations of the information processing apparatus will be given in place of description of the information processing method of the second example embodiment.

In the operations of the second example embodiment, first the processing of steps A1 to A3 is executed, as shown in FIG. 11. Note that because the processing of steps A1 to A3 and A5 has already been described, description thereof will be omitted.

The access needs calculation unit 81 calculates the access needs for the case where the access request is permitted, using the likelihoods for the access attributes (step B1).

Specifically, in step B1, first, the access needs calculation unit 81 derives attribute needs for each combination of estimated access attributes, with reference to the attribute needs assessment information, stored in advance in a storage device (not shown), in which combinations of access attributes are associated with attribute needs for each combination of access attributes. The access needs calculation unit 81 derives the access needs, using attribute needs assessment information, an attribute needs derivation model, or the like.

Next, in step B1, the access needs calculation unit 81 calculates the access needs for the access request, using the derived attribute needs and the likelihoods calculated by the likelihood calculation unit 12.

Specifically, the access needs calculation unit 81 calculates the access needs (weighted sum of likelihoods), using the plurality of likelihoods for each access attribute included in the combinations and the attribute needs set for each combination of access attributes.

Alternatively, the access needs may be derived using an access needs derivation model. In that case, data in which combinations of access attributes are associated with likelihoods corresponding to the combinations of access attributes is input into the attribute needs derivation model, and access needs for the access request are output.

The determination unit 82 determines whether to permit the access request for the information asset, based on the access risk and the access needs (step B2). Specifically, in step B1, first, the determination unit 82 acquires the access risk calculated by the access risk calculation unit 13 and the access needs calculated by the access needs calculation unit 81.

Next, in step B1, the determination unit 82 permits the access request for the information asset, if the access needs exceed the access risk. Conversely, if the access needs are less than or equal to the access risk, the access request for the information asset is not permitted.

Alternatively, the determination unit 82 determines whether to permit the access request for the information asset, based on the access permission information stored in a storage device (not shown) in advance.

In this way, the information processing apparatus 10a repeats the processing of steps A1 to A3, B1 to B2, and A5.

### Effects of Second Example Embodiment

According to the second example embodiment as described above, it can be determined whether to permit access, based on risk with respect to access to information assets. In particular, according to the second example embodiment, assessment of risk and needs takes account of the likelihoods for access attributes, and thus it can be determined whether to permit access, based on a more precise assessment of risk and needs.

### [Program]

The program according to the second example embodiment may be a program that causes a computer to execute steps A1 to A3, B1 to B2 and A5 shown in FIG. 11. By installing this program in a computer and executing the program, the information processing apparatus 10a and the information processing method according to the second example embodiment can be realized. Further, the processor of the computer performs processing to function as the access attribute estimation unit 11, the likelihood calculation unit 12, the access risk calculation unit 13, the access needs calculation unit 81, the determination unit 82, and the output information generation unit 15.

Also, the program according to the second example embodiment may be executed by a computer system constructed by a plurality of computers. In this case, for example, each computer may function as any of the access attribute estimation unit 11, the likelihood calculation unit 12, the access risk calculation unit 13, the access needs calculation unit 81, the determination unit 82, and the output information generation unit 15.

### Second Example Modification

A second example modification will now be described. In the second example modification, the determination unit 14 of the first example embodiment and the determination unit 82 of the second example embodiment may output a determination result other than whether or not to permit access for an access request. For example, the determination unit may, in addition to (i) permitting or (ii) not permitting an access request, output a determination result such as (iii) notifying the administrator or the like at the same time as permitting the access request, (iv) leaving a log to that effect at the same time as permitting the access request, (v) permitting the access request only for a certain time, and (vi) requesting additional authentication and permitting the access request only if the additional authentication is successful. Also, a determination result may be output by combining (i) to (vi).

Specifically, the determination unit 14 or 82 may perform determinations such as follows. For example, the access request is permitted if the access risk is less than or equal to a first threshold, using first and second thresholds set in advance. Also, if the access risk is greater than the first threshold and less than or equal to the second threshold, the access request is permitted and the administrator or the like is notified. Furthermore, if the access risk exceeds the second threshold, the access request is not permitted.

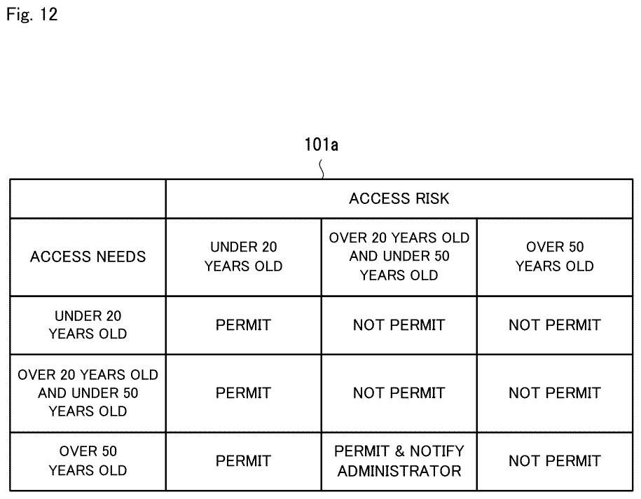

Alternatively, the determination unit 14 or 82 may determination whether to permit the access request, with reference to access permission information 101a such as shown in FIG. 12. FIG. 12 is for describing an example of access permission of the second example modification.

### Third Example Modification

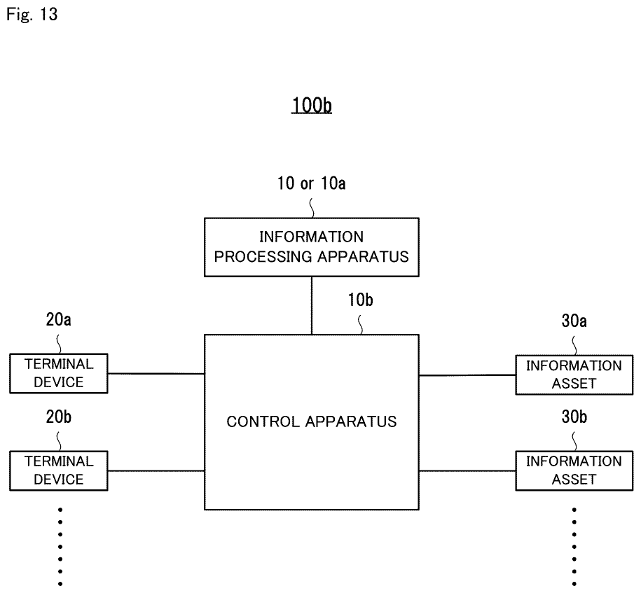

A third example modification will now be described. In the third example modification, the information processing apparatus 10 or the information processing apparatus 10a of the disclosure may be used in a system configuration such as shown in FIG. 13. FIG. 13 is for describing an example configuration of a system having the information processing apparatus of the third example modification. In a system 100b shown in FIG. 13, the terminal devices 20 and the information assets 30 are configured to communicate via a control apparatus 10b. Also, the information processing apparatus 10 or the information processing apparatus 10a is configured to be capable of communicating with the control apparatus 10b.

The control apparatus 10b is a device for controlling whether to allow the terminal devices 20 to access the information assets 30. The control apparatus 10b may be, for example, a switch, a router, an SDN (Software Defined Network) switch, a firewall, UTM (Unified Threat Management), NAC (Network Access Control), a proxy, an authentication gateway, an application gateway, an AD, or the like. Alternatively, the control apparatus 10b may be EDR (Endpoint Detection and Response) installed in the terminal devices.

When a terminal device 20 attempts to access an information asset 30, the control apparatus 10b transmits information relating to the access to the information processing apparatus 10 or the information processing apparatus 10a as an access request. The access request includes information such as, for example, an access source IP address of the access, an access destination IP address, an access source port number, an access destination port number, an access protocol, a user identifier, an access source terminal identifier, an access destination information asset identifier, authentication information, a token, and a ticket. The information included in the access request is, however, not limited to the information described above.

Next, the information processing apparatus 10 or the information processing apparatus 10a, having received an access request, determines whether to permit the access request, and transmits the determination result to the control apparatus 10b.

Next, the control apparatus 10b, having received the determination result for the access request, controls whether to allow access, in accordance with the determination result.

Alternatively, the information processing apparatus 10 or the information processing apparatus 10a transmits an access request anticipated in advance and a determination result therefor to the control apparatus 10b, and the control apparatus 10b controls whether to allow access to the terminal device, in accordance with the anticipated access request and the determination result therefor.

### [Physical Configuration]

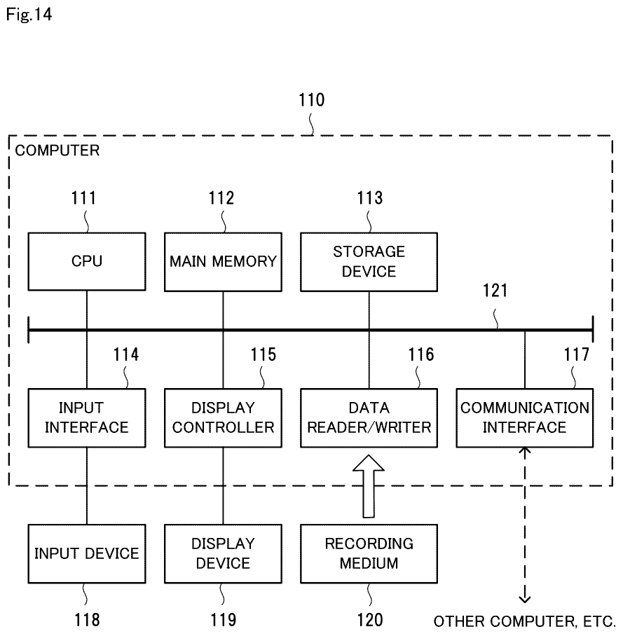

Here, a computer that realizes the information processing apparatus by executing the program according to the first example embodiment, the first example modification, second example embodiment, second example modification and the third example modification will be described with reference to FIG. 14. FIG. 14 is for describing an example of a computer that realizes the information processing apparatus of any of the first example embodiment, the first example modification, the second example embodiment, and the second and third example modifications.

As shown in FIG. 14, a computer 110 includes a CPU 111, a main memory 112, a storage device 113, an input interface 114, a display controller 115, a data reader/writer 116, and a communication interface 117. These units are connected via bus 121 so as to be able to perform data communication with each other. Note that the computer 110 may include a GPU or a FPGA in addition to the CPU111 or instead of the CPU111.

The CPU111 loads a program (codes) according to the first and second example embodiments and the first and second working examples stored in the storage device 113 to the main memory 112, and executes them in a predetermined order to perform various kinds of calculations. The main memory 112 is typically a volatile storage device such as a DRAM (Dynamic Random Access Memory).

Also, the program according to the example embodiments are provided in the state of being stored in a computer-readable recording medium 120. Note that the program according to the example embodiments may be distributed on the internet that is connected via the communication interface 117.

Specific examples of the storage device 113 include a hard disk drive, and a semiconductor storage device such as a flash memory. The input interface 114 mediates data transmission between the CPU 111 and the input device 118 such as a keyboard or a mouse. The display controller 115 is connected to a display device 119, and controls the display of the display device 119.

The data reader/writer 116 mediates data transmission between the CPU 111 and the recording medium 120, and reads out the program from the recording medium 120 and writes the results of processing performed in the computer 110 to the recording medium 120. The communication interface 117 mediates data transmission between the CPU 111 and another computer.

Specific examples of the recording medium 120 include general-purpose semiconductor storage devices such as a CF(Compact Flash (registered trademark)) and a SD (Secure Digital), a magnetic recording medium such as a flexible disk, and an optical recording medium such as a CD-ROM (Compact Disk Read Only Memory).

The information processing apparatus 10 and 10a according to the first example embodiment, the first example modification, second example embodiment, second example modification and the third example modification can also be achieved using hardware corresponding to the components, instead of a computer in which a program is installed. Furthermore, a part of information processing apparatus 10 or 10a may be realized by a program and the remaining part may be realized by hardware. In the first example embodiment, the first example modification, second example embodiment, second example modification, the computer is not limited to the computer shown in FIG. 8.

### [Supplementary Notes]

The following supplementary notes are also disclosed in relation to the above-described example embodiments. Although at least part or all of the above-described example embodiments can be expressed as, but are not limited to, Supplementary note 1 to Supplementary note 18 described below.

### (Supplementary Note 1)

An information processing apparatus comprising:
an access attribute estimating unit configured to estimate access attributes representing attributes for an access request for an information asset, transmitted to the information asset from a terminal device;
a likelihood calculation unit configured to calculate a likelihood for each access attribute;
an access risk calculation unit configured to calculate an access risk for the access request, using the likelihoods; and
a determination unit configured to determine whether to permit the access request for the information asset, based on the access risk.

### (Supplementary Note 2)

The information processing apparatus according to Supplementary note 1,
wherein the access risk calculation unit
   derives an attribute risk for each combination of the access attributes, and
   calculates the access risk for the access request, using the attribute risks and the likelihoods.

### (Supplementary Note 3)

The information processing apparatus according to Supplementary note 2,
wherein the access risk calculation unit inputs each combination of the access attributes into an attribute risk derivation model and outputs the attribute risk.

### (Supplementary Note 4)

The information processing apparatus according to Supplementary note 2,
wherein the access risk calculation unit inputs each combination of the access attributes and the likelihoods for each combination of the access attributes into an access risk derivation model, and outputs the access risk for the access request.

### (Supplementary Note 5)

The information processing apparatus according to any one of Supplementary note s 1 to 4, further comprising:
an access needs calculation unit configured to calculate access needs for a case where the access request is permitted, using the likelihoods for the access attributes;
wherein the determination unit determines whether to permit the access request for the information asset, based on the access risk and the access needs.

### (Supplementary Note 6)

The information processing apparatus according to Supplementary note 1,
wherein the access attributes include at least information representing a user of the terminal device, information representing a role of the user, and information representing a label of the information asset.

### (Supplementary Note 7)

An information processing method to be performed by an information processing apparatus, the method comprising:
estimating access attributes representing attributes for an access request for an information asset, transmitted to the information asset from a terminal device;
calculating a likelihood for each access attribute;
calculating an access risk for the access request, using the likelihoods; and
determining whether to permit the access request for the information asset, based on the access risk.

### (Supplementary Note 8)

The information processing method according to Supplementary note 7,
wherein the information processing apparatus
   deriving. an attribute risk for each combination of the access attributes, and
   calculating the access risk for the access request, using the attribute risks and the likelihoods.

### (Supplementary Note 9)

The information processing method according to Supplementary note 8,
wherein the information processing apparatus
   inputting each combination of the access attributes into an attribute risk derivation model and
   outputting the attribute risk.

### (Supplementary Note 10)

The information processing method according to Supplementary note 8,
wherein the information processing apparatus
   inputting each combination of the access attributes and the likelihoods for each combination of the access attributes into an access risk derivation model and
   outputting the access risk for the access request.

### (Supplementary Note 11)

The information processing method according to Supplementary notes 7 to 10,
wherein the information processing apparatus
   calculating access needs for a case where the access request is permitted, using the likelihoods for the access attributes;
   determining whether to permit the access request for the information asset, based on the access risk and the access needs.

### (Supplementary Note 12)

The information processing method according to Supplementary note 7,
wherein the access attributes include at least information representing a user of the terminal device, information representing a role of the user, and information representing a label of the information asset.

### (Supplementary Note 13)

A computer-readable recording medium including a program recorded thereon, the program including instructions that cause a computer to carry out:
estimating access attributes representing attributes for an access request for an information asset, transmitted to the information asset from a terminal device;
calculating a likelihood for each access attribute;
calculating an access risk for the access request, using the likelihoods; and
determining whether to permit the access request for the information asset, based on the access risk.

### (Supplementary Note 14)

The non-transitory computer readable recording medium according to Supplementary note 13,
wherein the program causes the computer to carry out:
   deriving. an attribute risk for each combination of the access attributes, and
   calculating the access risk for the access request, using the attribute risks and the

### (Supplementary Note 15)

The non-transitory computer readable recording medium according to Supplementary note 14,
wherein the program causes the computer to carry out:
   inputting each combination of the access attributes into an attribute risk derivation model and
   outputting the attribute risk.

### (Supplementary Note 16)

The non-transitory computer readable recording medium according to Supplementary note 14,
wherein the program causes the computer to carry out:
   inputting each combination of the access attributes and the likelihoods for each combination of the access attributes into an access risk derivation model and
   outputting the access risk for the access request.

### (Supplementary Note 17)

The non-transitory computer readable recording medium according to Supplementary notes 13 to 16,
wherein the program causes the computer to carry out:
   calculating access needs for a case where the access request is permitted, using the likelihoods for the access attributes;
   determining whether to permit the access request for the information asset, based on the access risk and the access needs.

### (Supplementary Note 18)

The non-transitory computer readable recording medium according to Supplementary note 13,
wherein the access attributes include at least information representing a user of the terminal device, information representing a role of the user, and information representing a label of the information asset.

Although the invention has been described with reference to the embodiments, the invention is not limited to the example embodiment described above. Various changes can be made to the configuration and details of the invention that can be understood by a person skilled in the art within the scope of the invention.

According to the technology described above, it can be determined whether to permit access to information assets, based on risk with respect to access to information assets that takes account of likelihood. In addition, it is useful in a field where the access to information assets is required.

While the invention has been particularly shown and described with reference to exemplary embodiments thereof, the invention is not limited to these embodiments. It will be understood by those of ordinary skill in the art that various changes in form and details may be made therein without departing from the spirit and scope of the present invention as defined by the claims.

What is claimed is:

1. An information processing apparatus comprising:
one or more memories storing instructions; and
one or more processors configured to execute the instructions to:
estimate access attributes representing attributes for an access request for an information asset, transmitted to the information asset from a terminal device;
calculate a likelihood for each access attribute;
calculate an access risk for the access request, using the likelihoods; and
determine whether to permit the access request for the information asset, based on the access risk.

2. The information processing apparatus according to claim 1, wherein the one or more processors further:
derive an attribute risk for each combination of the access attributes, and
calculate the access risk for the access request, using the attribute risks and the likelihoods.

3. The information processing apparatus according to claim 2, wherein the one or more processors further:
input each combination of the access attributes into an attribute risk derivation model and outputs the attribute risk.

4. The information processing apparatus according to claim 2, wherein the one or more processors further:
input each combination of the access attributes and the likelihoods for each combination of the access attributes into an access risk derivation model, and output the access risk for the access request.

5. The information processing apparatus according to claim 1, wherein the one or more processors further:
calculate access needs for a case where the access request is permitted, using the likelihoods for the access attributes;
in the determine whether to permit the access request for the information asset, based on the access risk and the access needs.

6. The information processing apparatus according to claim 1,
wherein the access attributes include at least information representing a user of the terminal device, information representing a role of the user, and information representing a label of the information asset.

7. An information processing method to be performed by an information processing apparatus, the method comprising:
estimating access attributes representing attributes for an access request for an information asset, transmitted to the information asset from a terminal device;
calculating a likelihood for each access attribute;
calculating an access risk for the access request, using the likelihoods; and
determining whether to permit the access request for the information asset, based on the access risk.

8. A non-transitory computer-readable recording medium including a program recorded thereon, the program including instructions that cause a computer to carry out:
estimating access attributes representing attributes for an access request for an information asset, transmitted to the information asset from a terminal device;
calculating a likelihood for each access attribute;
calculating an access risk for the access request, using the likelihoods; and
determining whether to permit the access request for the information asset, based on the access risk.
